(19) United States
(12) Patent Application Publication
(10) Pub. No.: US 2014/0231132 A1
(43) Pub. Date: Aug. 21, 2014

(54) WATERSTOP MEMBER OF CABLE INSERTION HOLE AND ELECTRONIC APPARATUS PROVIDED WITH THAT WATERSTOP MEMBER

(71) Applicant: Fujitsu Mobile Communications Limited, Kawasaki-shi (JP)

(72) Inventor: Masamichi Watanabe, Kawasaki (JP)

(73) Assignee: FUJITSU MOBILE COMMUNICATIONS LIMITED, Kawasaki-shi (JP)

(21) Appl. No.: 14/133,928

(22) Filed: Dec. 19, 2013

(30) Foreign Application Priority Data
Feb. 20, 2013 (JP) 2013-031115

(51) Int. Cl. H02G 15/013

(52) U.S. Cl. CPC H02G 15/013
USPC 174/650

(57) ABSTRACT

A waterstop member of a cable insertion hole of an electronic apparatus made of rubber, provided with a taper shaped inside member which is positioned at the inside of the housing, a hole member which closely contacts the cable insertion hole, and a thick walled outside member which is positioned at the outside of the housing, the cable hole which runs through the inside member, hole member, and outside member and in which the pull-out cable is inserted being provided with a waterstop ring, a thick wall part of the outside member being provided with a circumferential groove which is provided with a diameter which is larger than the cable hole, a bottom surface of the circumferential groove is provided with water drainage holes which communicate with the outside, and the cable hole being designed so that water will not enter the inside of the housing when the cable moves.

### CROSS-REFERENCE TO RELATED APPLICATION

This application claims priority from, and incorporates by reference the entire disclosure of, Japanese Patent Application No. 2013-031115, filed on Feb. 20, 2013.

### FIELD

The present application relates to a waterstop member of a cable insertion hole which stops water from entering an insertion hole which is provided at an electronic apparatus for a cable which connects a functional part which is used detached from the electronic apparatus with the electronic apparatus and to an electronic apparatus which is provided with that waterstop member.

### BACKGROUND

In the past, electronic apparatuses which can be carried about, for example, mobile phones, have often been provided with waterproof structures. Further, in electronic apparatuses which are provided with waterproof structures, in general a waterproofing-use packing is inserted into the joined parts of the lower housing and upper housing of the electronic apparatus. Further, in a waterproof specification mobile phone, when the main body is provided with a fingerprint sensor or camera, a waterproof structure using a packing, waterproof seal, etc. has been provided between the fingerprint sensor and the main body and between the camera lens and main body. There is a description of provision of a fingerprint sensor at the main body of a mobile phone in for example Japanese Laid-Open Patent Publication No. 2009-4958, while there is a description of a mobile phone having a waterproof structure in for example Japanese Laid-Open Patent Publication No. 2008-301440.

Further, in recent years, electronic apparatuses with larger screens than mobile phones, for example, smart phones and tablets, have been spreading. In electronic apparatuses with large sized screens, the housings also become larger in size, so the functions mounted also increase. Such smart phones and tablets are often carried outdoors for use, so a waterproof function is becoming essential in the same way as with mobile phones.

FIG. 1A is a view of one example of a smart phone 1 of one aspect of an electronic apparatus as seen from a display screen side, while FIG. 1B is a view of a smart phone 1 which is illustrated in FIG. 1A as seen from the back side. After this, the electronic apparatus and smart phone will be assigned the same reference numeral 1 for the explanation. At the center of the smart phone 1, there is a display 6. At the upper side, there is a reception-use speaker 7, while at the lower side, there is a transmission-use microphone 8 and operating button 9. Further, at the back side of the smart phone 1, as functional parts, a camera 41, fingerprint sensor 42, and charging terminal 43 are provided.

On the other hand, in a waterproof specification flip-open type mobile phone in the related art, a waterproof structure is provided at the rotating connecting part of the two housings, but a waterproof cable is used, so the structure is complicated and the manufacture and cost are disadvantageous. For example, the waterproof structure which is employed for a waterproof structure flip-open type mobile phone is difficult to use for the waterproof structure of a smart phone or tablet. Further, as shown in FIG. 1B, when a smart phone 1 is provided with a fingerprint sensor 42, the fingerprint sensor 42 is attached to the back side housing, so there is the issue that the fingerprint sensor 42 is hard to use.

### SUMMARY

In one aspect, the present application has as its object the provision of a waterstop member of a cable insertion hole which stops water from entering an insertion hole in an electronic apparatus of a cable which connects a functional part, which is used detached from the electronic apparatus in a waterproof specification electronic apparatus, with an electronic apparatus. In another aspect, there is provided an electronic apparatus which is provided with a functional part which is used detached from the main body of the electronic apparatus and which uses a waterstop member of a cable insertion hole which stops water from entering a cable insertion hole which is provided at the electronic apparatus for a cable which connects the functional part with the main body of the electronic apparatus.

According to one aspect of the embodiment, there is provided a waterstop member of a cable insertion hole which is attached to a cable insertion hole which is provided at a waterproof specification housing of an electronic apparatus, wherein the waterstop member is provided with an inside member which is positioned at the inside of the housing, a hole member which is contiguous with the inside member and which is positioned at a part of the cable insertion hole which is provided at the housing, and an outside member which is contiguous with the hole member and which is positioned at the outside of the housing, the inside member is provided with a tip which is narrower than a diameter of the cable insertion hole and a base which is broader than a diameter of the cable insertion hole, the hole member is provided with an outer circumferential surface which closely contacts an inner circumferential surface of the cable insertion hole in a watertight manner, the outside member is provided with a shape which is larger than the cable insertion hole and a predetermined wall thickness, the cable hole which runs through the inside member, the hole member, and the outside member and through which a cable is inserted at the part of the hole member of which a first waterstop ring is provided and at the part of the outside member of which a circumferential groove which is provided with a diameter larger than the diameter of the cable hole is provided, and an outer circumferential surface of the circumferential groove is provided with at least one water drainage hole which communicates with the outside surface of the outside member.

According to another aspect of the embodiment, there is provided an electronic apparatus which is provided with a waterproof specification housing and a functional part which is used detached from the housing, the functional part being connected with a circuit board in the housing by a cable which leaves and enters the housing through a cable insertion hole which is provided at the housing, the inside of the housing being provided with a windup mechanism of the cable, the cable insertion hole being provided with a waterstop member of the cable insertion hole, wherein the waterstop member is provided with an inside member which is positioned at the inside of the housing, a hole member which is contiguous with the inside member and which is positioned at a part of the cable insertion hole which is provided at the housing, and an outside member which is contiguous with the hole member and which is positioned at the outside of the housing, the inside member is provided with a tip which is narrower than a diameter of the cable insertion hole and a base which is broader than a diameter of the cable insertion hole, the hole member is provided with an outer circumferential surface which closely contacts an inner circumferential surface of the cable insertion hole in a watertight manner, the outside member is provided with a shape which is larger than the cable insertion hole and a predetermined wall thickness, the cable hole which runs through the inside member, the hole member, and the outside member and through which a cable is inserted is provided with a first waterstop ring at the part of the hole member and is provided with a circumferential groove which is provided with a diameter larger than the diameter of the cable hole at the part of the outside member, and an outer circumferential surface of the circumferential groove is provided with at least one water drainage hole which communicates with the outside surface of the outside member.

### BRIEF DESCRIPTION OF DRAWINGS

FIG. 1A is a perspective view of one example of a smart phone of one aspect of an electronic apparatus.

FIG. 1B is a perspective view which illustrates a back side of the smart phone which is illustrated in FIG. 1A.

FIG. 2A is a perspective view of an electronic apparatus which is provided with a detachable type functional part as seen from the front side.

FIG. 2B is a partial perspective view of an upper side of the electronic apparatus which is illustrated in FIG. 2A as seen from an arrow A direction.

FIG. 3A is a partial enlarged cross-sectional view of an upper side of the smart phone which is illustrated in FIG. 2A.

FIG. 3B is a perspective view of a waterstop member of a cable insertion hole which is illustrated in FIG. 3A.

FIG. 3C is a perspective view of a waterstop member of a cable insertion hole which is illustrated in FIG. 3AB as seen from the opposite side.

FIG. 4A is a perspective view which includes a cross-section of a waterstop member of a cable insertion hole which is illustrated in FIG. 3A.

FIG. 4B is a perspective view which illustrates the state where a cable is passed through a waterstop member of a cable insertion hole which is illustrated in FIG. 4A.

FIG. 4C is a partial enlarged perspective view of a part B of FIG. 4B.

FIG. 4D is a partial enlarged perspective view which illustrates the state where a cable is passed through a waterstop member of a cable insertion hole which is illustrated in FIG. 4C.

FIG. 4E is a partial enlarged cross-sectional view which illustrates another embodiment of a waterstop member of a cable insertion hole.

FIG. 4F is a partial enlarged cross-sectional view which illustrates the state where a cable is passed through a waterstop member of a cable insertion hole which is illustrated in FIG. 4A.

FIG. 5A is a partial perspective view of one embodiment of an outside member of a waterstop member of a cable insertion hole.

FIG. 5B is a partial enlarged cross-sectional view which illustrates the state where a cable is pulled out from an outside member of a waterstop member of a cable insertion hole which is illustrated in FIG. 5A.

FIG. 5C is a partial enlarged cross-sectional view which illustrates the state when a cable is pulled into the housing from an outside member of a cable insertion hole which is illustrated in FIG. 5A.

FIG. 6A is a disassembled cross-sectional view which illustrates a waterproof structure of a functional part which is illustrated in FIG. 2.

FIG. 6B is a cross-sectional view of a functional part which is illustrated in FIG. 2.

### DESCRIPTION OF EMBODIMENTS

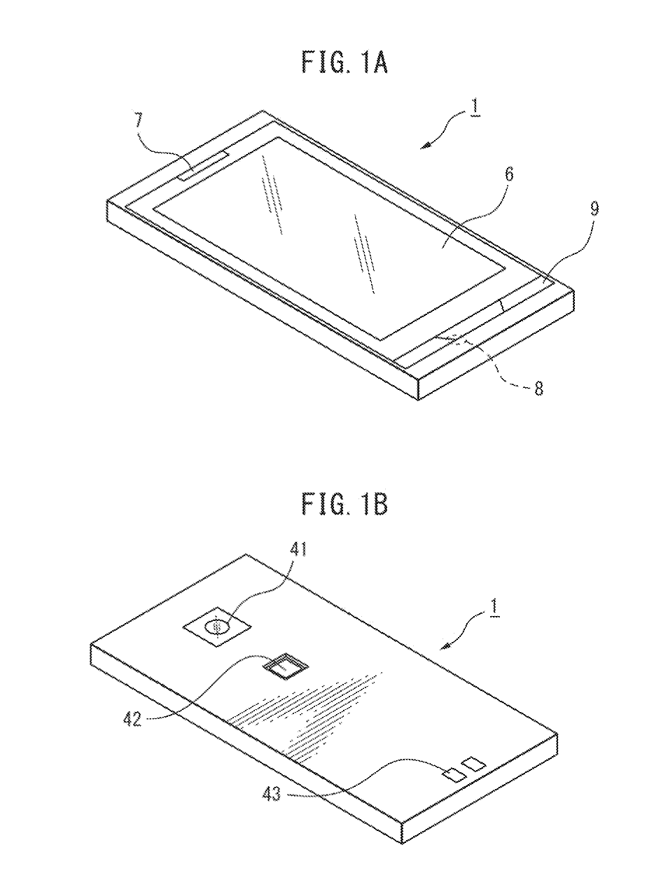

Below, embodiments of the present application will be explained in detail based on specific examples using the attached drawings. Note that, component members the same as the smart phone 1 of the comparative art which was explained by FIG. 1A and FIG. 1B are explained while assigned the same reference notations.

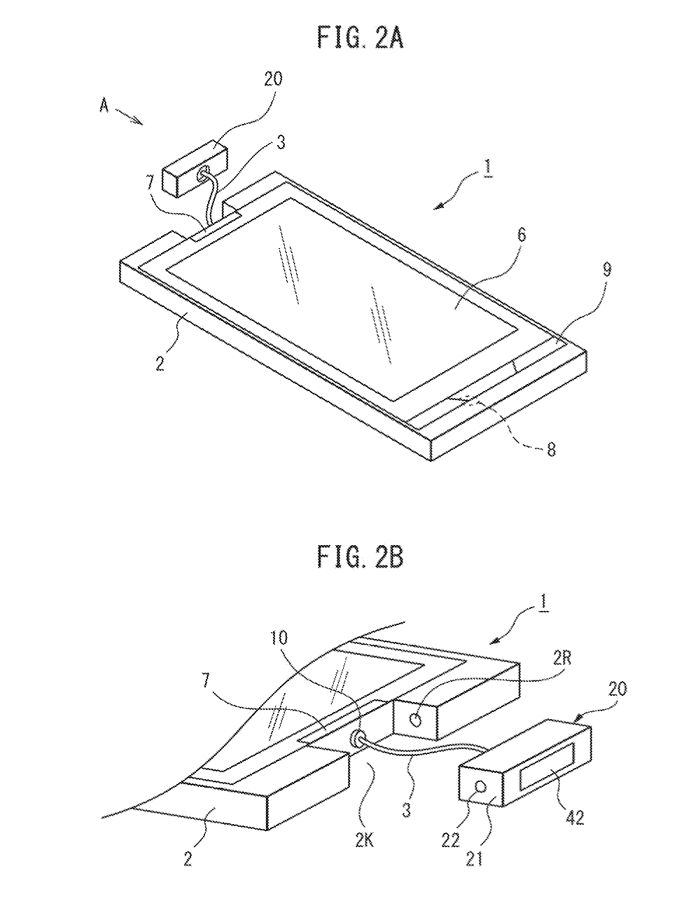

FIG. 2A is a view of an electronic apparatus which is provided with a detachable type functional part 20, for example, a fingerprint sensor unit 20, that is, a smart phone 1, seen from the side where the display 6 is provided. The display 6 is at the center part of the smart phone 1. At the upper side, there is a reception-use speaker 7, while at the lower side, there is transmission-use microphone 8 and operating button 9. The smart phone 1 of the present application is a waterproof specification. The fingerprint sensor unit 20 which is used detached from the top part of the smart phone 1 is also a waterproof specification. The waterproof specification of the fingerprint sensor unit 20 will be explained later. Further, the fingerprint sensor unit 20 includes a pullout cable 3 which is pulled out from the waterproof specification housing 2 of the smart phone 1 (below, simply called the “housing 2”).

FIG. 2B illustrates the upper side of the smart phone 1 which is illustrated in FIG. 2A as seen from the arrow A direction. At the top part of the housing 2 of the smart phone 1, there is a cutaway part 2K. In this cutaway part 2K, a fingerprint sensor unit 20 is fit. At the two sides of the housing 21 of the fingerprint sensor unit 20, there is provided a retractable projection 22 which retracts into the housing 21 when pressed. The retractable projection 22 projects out from the housing 21 by the biasing force of a spring etc. in the state when not pressed from the outside. For example, when fitting the fingerprint sensor unit 20 into the cutaway part 2K, this retractable projection 22 is made to retract into the housing 21 of the fingerprint sensor unit 20. Further, when the fingerprint sensor unit 20 is completely fit into the cutaway part 2K, the retractable projection 22 projects out into the recess 2R of the cutaway part 2K and engages with it.

The fingerprint sensor unit 20 is connected to the smart phone 1 by a pull-out cable 3 (below, simply called the “cable 3”). Further, when detaching the fingerprint sensor unit 20 from the housing of the smart phone 1, the cable 3 is pulled out from the housing 2 of the smart phone 1. Further, when returning the fingerprint sensor unit 20 to the cutaway part 2K of the housing 2 of the smart phone 1, the cable 3 is automatically pulled inside the housing 2.

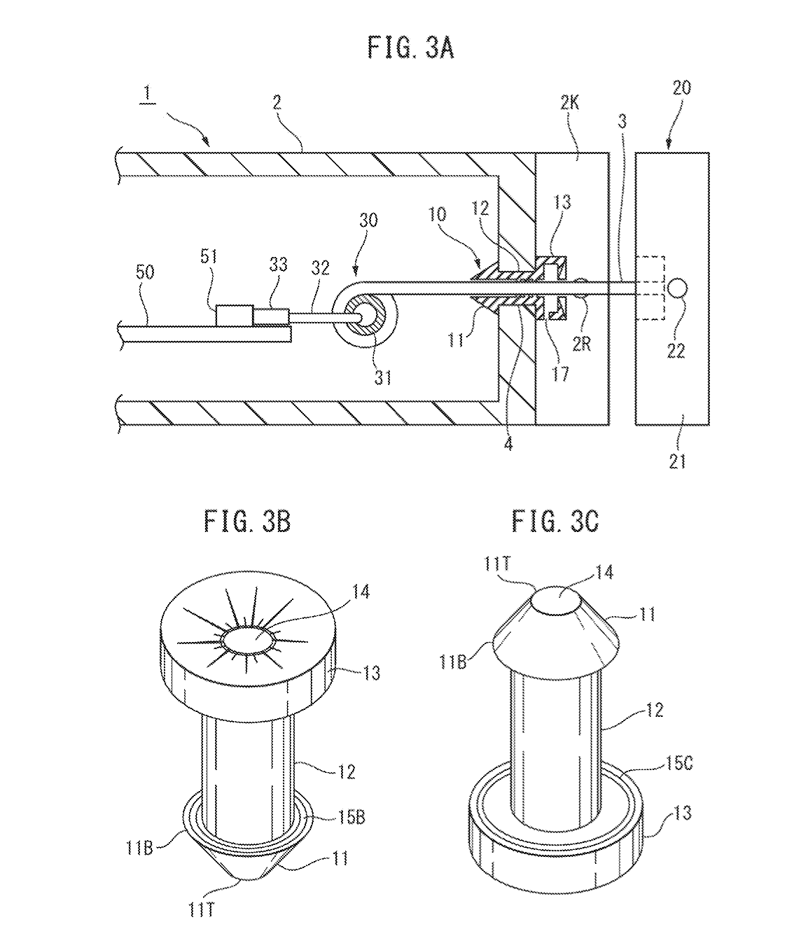

The cable 3 moves through the cable insertion hole which is provided at the housing 2 of the smart phone 1 (see FIG. 3A), but the housing 2 of the smart phone 1 is a waterproof specification, so in the present application, the cable insertion hole is provided with a waterstop member 10 of the cable insertion hole. Further, in the present application, the waterstop member 10 of the cable insertion hole satisfies the following conditions:
(1) Water is stopped from entering between the housing 2 of the smart phone 1 and the waterstop member 10 of the cable insertion hole
(2) Water is stopped from entering between the waterstop member 10 of the cable insertion hole and the cable 3 which moves through this member
(3) Dustproofing/waterproofing is made more reliable

Here, the structure of the waterstop member 10 of the cable insertion hole which satisfies the above conditions (1) to (3) and the structure of the smart phone 1 which is provided with the waterstop member 10 of the cable insertion hole will be explained while using FIG. 3 to FIG. 6

FIG. 3A is a cross-sectional view which partially enlarges the upper side of the smart phone 1 which is illustrated in FIG. 2A and illustrates the state where the fingerprint sensor unit 20 is detached from the cutaway part 2K of the housing 2. At the inside of the housing 2, there is the cable windup mechanism 30. On its reel 31, a cable 3 is wound. The cable windup mechanism 30 has a spring, not illustrated, attached to it. This spring biases the reel 31 at the side taking up the cable 3. The structure of the cable windup mechanism 30 which is used in the electronic apparatus is known, so the explanation will be omitted here. A signal takeout line 32 is pulled out from the cable windup mechanism 30. At the free end of the signal takeout line 32, there is a connector 33. This connector 33 is connected to the connector 51 which is mounted on the circuit board 50 which is provided at the inside of the housing 2. Due to this configuration, the signal which is detected by the fingerprint sensor unit 20 is transmitted to and processed by the circuit board 50.

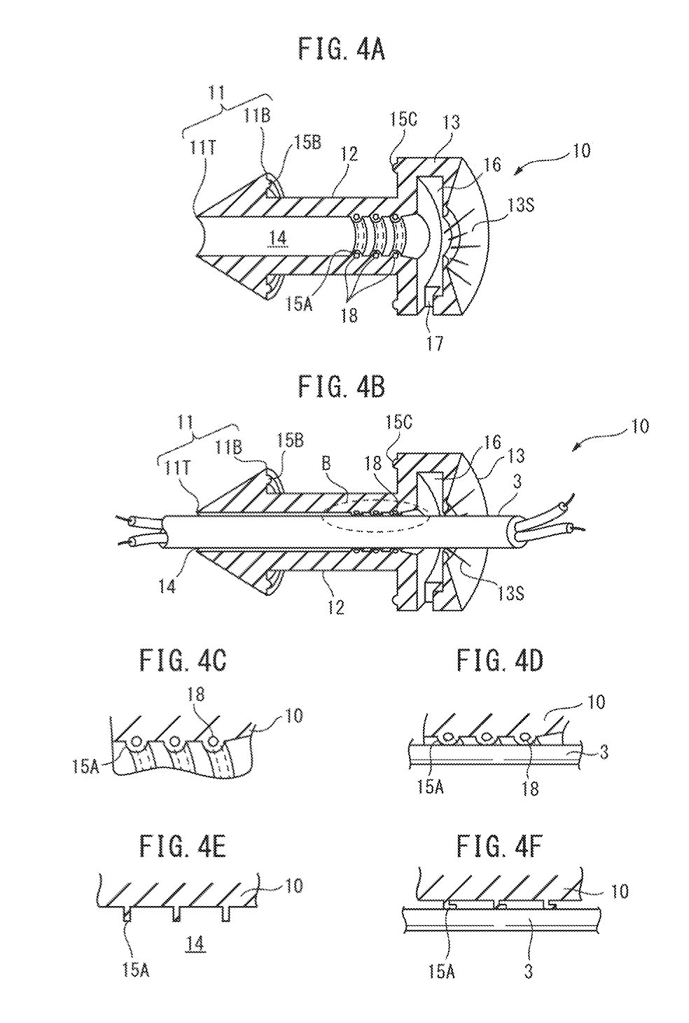

Further, the cable insertion hole 4 which is provided at the housing 2 of the smart phone 1 has a waterstop member 10 attached to it. The structure of the waterstop member 10 of the cable insertion hole 4 will be explained while using FIG. 3B, FIG. 3C, and FIG. 4A. FIG. 3B is a perspective view which views the waterstop member 10 of the cable insertion hole 4 which is illustrated in FIG. 3A taken out from the housing 2, while FIG. 3C is a perspective view which views the waterstop member 10 which is illustrated in FIG. 3B from the opposite side. Further, FIG. 4A illustrates the cross-section at the axis which passes through the center of the waterstop member 10 which is illustrated in FIG. 3A.

As will be understood from these figures, the waterstop member 10 of the cable insertion hole 4 is provided with an inside member (anchor member) 11, hole member 12, and outside member 13 and is formed by a flexible rubber material. The inside member 11 is positioned at the inside of the housing 2 and is provided at the tip 11T, which is narrower than the diameter of the cable insertion hole 4, and the base 11B, which is thicker than the diameter of the cable insertion hole 4. The hole member 12 is provided contiguous to the inside member 11 and is positioned at the part of the cable insertion hole 4 which is provided at the housing 2. The outer circumferential surface is in close contact with the cable insertion hole 4 so that water is not passed. The outside member 13 is provided contiguous with the hole member 12, is positioned at the outside of the housing 2, and is provided with a shape larger than the cable insertion hole 4 and a predetermined wall thickness.

Further, at the surface of the base 11B of the inside member 11 abutting against the housing 2, a waterstop ring 15B is provided for reliably stopping the entry of water between the base 11B and the housing 2. Furthermore, at the surface of the outside member 13 abutting against the housing 2, a waterstop ring 15C is provided for reliably stopping water from entering between the outside member 13 and the housing 2. The cross-sections of these waterstop rings 15B, 15C are semicircular in this embodiment.

On the other hand, the cable hole 14 which runs through the inside member 11, hole member 12, and outside member 13 and in which the cable 3 is inserted is provided with three waterstop rings 15A at the part of the hole member 12 at predetermined intervals. Further, the insides of these waterstop rings 15A are provided with air rings 18 for facilitating deformation of the waterstop rings 15A. The air rings 18 are empty parts for causing the projecting parts of the waterstop rings 15A to deform. The air rings 18, as illustrated in FIG. 4C, are circular in cross-section in the state where there is no cable in the cable hole 14, but are shapes which are pressed and crushed as illustrated in FIG. 4B and FIG. 4D in the state where there is a cable 3 in the cable hole 14.

In a comparative structure which uses an O-ring, the O-ring itself becomes a solid structure of a rubber material, so the rubber itself is thick and the pressure (counterforce) when holding down the cable 3 becomes stronger. For example, it is difficult for the cable 3 to slide inside the cable hole 14. As opposed to this, if providing an air ring 18 inside the waterstop ring 15A, the counterforce is reduced compared with the counterforce of just the rubber. That is, if providing the air ring 18 in the waterstop ring 15A, the number of deformation strokes of the waterstop ring 15A increases due to the crushing of the air ring 18 at the time of applying pressure, so the cable 3 can be made to slide inside the cable hole 14 in the state stopping water from entering.

Note that, regarding the shape of the waterstop ring 15A, the cross-section including the air ring 18 may be made a semicircular shape. In addition, as illustrated in FIG. 4E, the cross-section which projects out from the inner circumference of the cable hole 14 can be made a rectangular shape of a thin wall thickness. If making the wall thickness of the waterstop ring 15A thin in this way, at the time of movement of the cable 3, the waterstop ring 15A collapses in the direction of movement of the cable 3, so the cable 3 can be slid in a state reliably stopping water from entering.

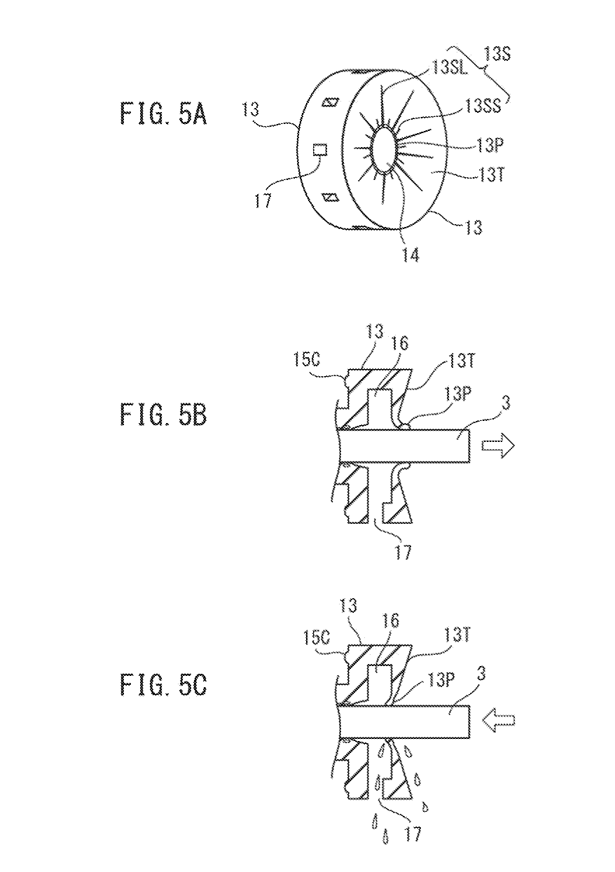

Next, the structure of the outside member 13 will be explained. In this embodiment, as illustrated in FIG. 3B and FIG. 3C, the outside shape of the outside member 13 is a columnar shape, but the outside shape of the outside member 13 need not be a columnar shape. At the inside of the outside member 13, as illustrated in FIG. 4A, a circumferential groove 16 which is provided with a diameter which is larger than the diameter of the cable hole 14 is provided. At the outer circumferential surface of the circumferential groove 16, at least one water drainage hole which is communicated with the outer surface of the outside member 13 is provided. FIG. 5A illustrates an embodiment where eight water drainage holes 17 are provided at the outer surface of the outside member 13. If increasing the number of the water drainage holes 17, the strength of the outside member 13 falls, but if providing a suitable number, it is no longer necessary to select the orientation when attaching the waterstop member 10 of the cable insertion hole in the cable insertion hole 4 of the housing 2 and the work efficiency in attachment is improved.

Further, at the free end face of the outside member 13, a taper part 13T which is inclined from the outside of the outside member 13 toward the cable hole 14 side is provided. The taper part 13T is provided with slits 13S radially from the cable hole 14 side toward the outside. The slits 13S are connected up to the circumferential groove 16. In this embodiment, as the slits 13S, long slit length slits 13SL and short slight length slits 13SS, that is, different length slits 13S, are alternately provided. If providing slits 13 in the taper part 13T in this way, the tip 13P of the taper part 13T can deform in the direction of movement of the cable. FIG. 5B illustrates deformation of the tip 13P of the taper part 13T when the cable 3 is pulled out from the outside member 13, while FIG. 5C illustrates deformation of the tip 13P of the taper part 13T when the cable 3 is pulled into the housing 2 from the outside member 13.

Due to these slits 13S, work is performed to decrease the resistance when the cable 3 is pulled inside the housing 2 while removing dust and moisture which deposited on the outer circumference of the cable 3 at the tip 13P. The structure of the taper part 13T is also called an “initial water draining valve”. Further, it is possible to use the long slit length slits 13SL to make a part with large elastic force and secure the holding force of the cable 3 and possible to use a part of the short slit length slits 13SS to follow the outer circumference of the cable. Dust or moisture which has deposited at the outer circumference of the cable 3 is removed by the tip 13P and drops down from the taper part 13T and the water drainage hole 17. This state is illustrated in FIG. 5C.

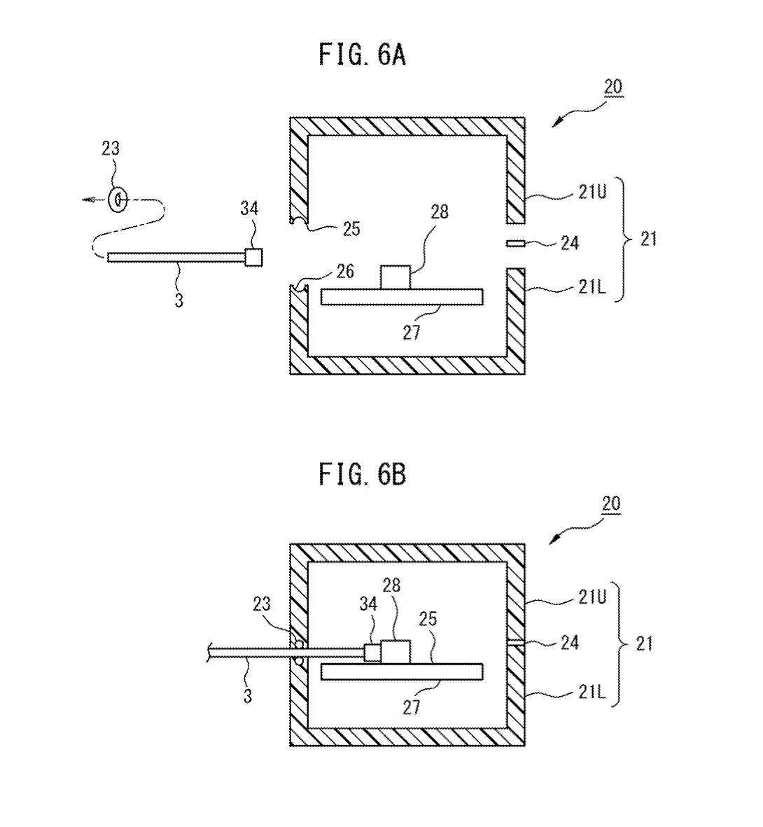

Finally, FIG. 6 will be used to explain one embodiment of a functional part, that is, a fingerprint sensor unit 20. FIG. 6A illustrates the housing 21 of the functional part 20 which is illustrated in FIG. 2 divided into the top and bottom. The housing 21 is provided with an upper housing 21U and a lower housing 21L. The inside is provided with a circuit board 27 on which the connector 28 is mounted. Illustration of the fingerprint sensor which is mounted on the circuit board 27 will be omitted. An O-ring 23 is inserted over the cable 3 which connects the fingerprint sensor unit 20 to the smart phone. This O-ring 23 is fit into a ring-shaped recess 26 which is provided at the inner circumference of the cable insertion hole 25 which is provided at the upper housing 21U and the lower housing 21L. The joined parts of the upper housing 21U and the lower housing 21L other than at the cable insertion hole 25 are given a waterproof seal 24. The upper housing 21U and the lower housing 21L are thereby joined. FIG. 6B is a cross-sectional view of one embodiment of the fingerprint sensor unit 20.

By using a waterstop member of a cable insertion hole of the embodiment which was explained above to a smart phone of a structure which pulls out the functional part from the housing which is provided with a waterproof structure in this way, it becomes possible to improve the product quality of the smart phone, improve the work efficiency, and reduce the cost accompanying this. Further, in the above embodiment, as the electronic apparatus, a smart phone was explained, but a waterstop member of a cable insertion hole of the present application can be broadly applied to tablets and electronic apparatuses which are provided with portable waterproof specification housings.

Note that, in the embodiments which were explained above, a fingerprint sensor unit was explained as a functional part, but as the functional part, in addition, a bio signal detection sensor unit which detects the bio signal to measure the pulse or blood pressure etc. may be considered.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. A waterstop member of a cable insertion hole which is attached to a cable insertion hole which is provided at a waterproof specification housing of an electronic apparatus, wherein
said waterstop member is provided with:
an inside member which is positioned at the inside of said housing,
a hole member which is contiguous with said inside member and which is positioned at a part of the cable insertion hole which is provided at said housing, and
an outside member which is contiguous with said hole member and which is positioned at the outside of said housing,
said inside member is provided with a tip which is narrower than a diameter of said cable insertion hole and a base which is broader than a diameter of said cable insertion hole,
said hole member is provided with an outer circumferential surface which closely contacts an inner circumferential surface of said cable insertion hole in a watertight manner,
said outside member is provided with a shape which is larger than said cable insertion hole and a predetermined wall thickness,
the cable hole which runs through said inside member, said hole member, and said outside member and through which a cable is inserted is provided with a first waterstop ring at the part of said hole member and is provided with a circumferential groove which is provided with a diameter larger than the diameter of said cable hole at the part of said outside member, and
an outer circumferential surface of said circumferential groove is provided with at least one water drainage hole which communicates with the outside surface of said outside member.

2. The waterstop member of a cable insertion hole according to claim 1, wherein the waterstop member of said cable insertion hole is formed by a flexible rubber material.

3. The waterstop member of a cable insertion hole according to claim 1, wherein
said inside member is provided with a second waterstop ring at an abutting surface of said base with said housing, and
the abutting surface of said outside member with said housing is provided with a third waterstop ring.

4. The waterstop member of a cable insertion hole according to claim 2, wherein
said inside member is provided with a second waterstop ring at an abutting surface of said base with said housing, and
the abutting surface of said outside member with said housing is provided with a third waterstop ring.

5. The waterstop member of a cable insertion hole according to claim 1, wherein said first waterstop ring is provided at a plurality of locations in the axial direction of said cable hole.

6. The waterstop member of a cable insertion hole according to claim 4, wherein said first waterstop ring is provided at a plurality of locations in the axial direction of said cable hole.

7. The waterstop member of a cable insertion hole according to claim 5, wherein said first waterstop ring has a semicircular shape cross-section which projects out from the inner circumferential surface of said cable hole and wherein said first waterstop ring is provided at its inside with an air ring which changes the height of said first waterstop ring from said cable hole.

8. The waterstop member of a cable insertion hole according to claim 6, wherein said first waterstop ring has a semicircular shape cross-section which projects out from the inner circumferential surface of said cable hole and wherein said first waterstop ring is provided at its inside with an air ring which changes the height of said first waterstop ring from said cable hole.

9. The waterstop member of a cable insertion hole according to claim 5, wherein, due to said partition wall, said first waterstop ring has a rectangular shape cross-section which projects out from the inner circumferential surface of said cable hole and collapses in the direction of movement of the pull-out cable at the time of movement of said pull-out cable.

10. The waterstop member of a cable insertion hole according to claim 6, wherein, due to said partition wall, said first waterstop ring has a rectangular shape cross-section which projects out from the inner circumferential surface of said cable hole and collapses in the direction of movement of the pull-out cable at the time of movement of said pull-out cable.

11. The waterstop member of a cable insertion hole according to claim 1, wherein a free end face of said outside member is provided with a taper part which is inclined from an outside of said outside member toward said cable hole side, and said taper part is provided with radial slits from said cable hole side toward the outside.

12. The waterstop member of a cable insertion hole according to claim 8, wherein a free end face of said outside member is provided with a taper part which is inclined from an outside of said outside member toward said cable hole side, and said taper part is provided with radial slits from said cable hole side toward the outside.

13. The waterstop member of a cable insertion hole according to claim 10, wherein a free end face of said outside member is provided with a taper part which is inclined from an outside of said outside member toward said cable hole side, and said taper part is provided with radial slits from said cable hole side toward the outside.

14. The waterstop member of a cable insertion hole according to claim 11, wherein as said slits, ones with different slit lengths are alternately provided.

15. The waterstop member of a cable insertion hole according to claim 12, wherein as said slits, ones with different slit lengths are alternately provided.

16. The waterstop member of a cable insertion hole according to claim 13, wherein as said slits, ones with different slit lengths are alternately provided.

17. An electronic apparatus which is provided with a waterproof specification housing and a functional part which is used detached from said housing, said functional part being connected with a circuit board in said housing by a cable which leaves and enters said housing through a cable insertion hole which is provided at said housing, the inside of said housing being provided with a windup mechanism of said cable, said cable insertion hole being provided with a waterstop member of the cable insertion hole, wherein
said waterstop member is provided with:
an inside member which is positioned at the inside of said housing,
a hole member which is contiguous with said inside member and which is positioned at a part of the cable insertion hole which is provided at said housing, and
an outside member which is contiguous with said hole member and which is positioned at the outside of said housing,
said inside member is provided with a tip which is narrower than a diameter of said cable insertion hole and a base which is broader than a diameter of said cable insertion hole,
said hole member is provided with an outer circumferential surface which closely contacts an inner circumferential surface of said cable insertion hole in a watertight manner,
said outside member is provided with a shape which is larger than said cable insertion hole and a predetermined wall thickness,
the cable hole which runs through said inside member, said hole member, and said outside member and through which a cable is inserted is provided with a first waterstop ring at the part of said hole member and is provided with a circumferential groove which is provided with a diameter larger than the diameter of said cable hole at the part of said outside member, and
an outer circumferential surface of said circumferential groove is provided with at least one water drainage hole which communicates with the outside surface of said outside member.

18. The electronic apparatus according to claim 17, wherein said functional part is a fingerprint sensor.

19. The electronic apparatus according to claim 17, wherein the housing of said functional part is a waterproof specification.

20. The electronic apparatus according to claim 18, wherein the housing of said functional part is a waterproof specification.
